(19) United States
(12) Patent Application Publication
(10) Pub. No.: US 2026/0075377 A1
(43) Pub. Date: Mar. 12, 2026

(54) INFORMATION PROCESSING APPARATUS, INFORMATION PROCESSING SYSTEM, INFORMATION PROCESSING METHOD, AND PROGRAM

(71) Applicant: SONY GROUP CORPORATION, TOKYO (JP)

(72) Inventors: YOSUKE HORIBA, TOKYO (JP); TAKAHISA TAGAMI, TOKYO (JP); SHO KAYASHIMA, TOKYO (JP)

(21) Appl. No.: 19/108,184

(22) PCT Filed: Aug. 1, 2023
(86) PCT No.: PCT/JP2023/028041

§ 371 Date: Mar. 3, 2025

(30) Foreign Application Priority Data
Sep. 9, 2022 (JP) 2022-143778

(51) Int. Cl. H04S 7/00; H04R 5/02

(52) U.S. Cl. CPC H04S 7/301; H04R 5/02; H04S 2400/11; H04S 2400/15

(57) ABSTRACT

For example, one object is to realize more excellent sound field correction. An information processing apparatus includes a control unit that converts a transfer characteristic of a sound pressure from a speaker device to a listening position into an energy characteristic, and calculates a correction parameter for correcting a sound field generated by an output sound of the speaker device using the converted energy characteristic.

### TECHNICAL FIELD

The present disclosure relates to an information processing apparatus, an information processing system, an information processing method, and a program.

### BACKGROUND ART

A technique is known in which sound of a test signal output from a speaker is collected by a microphone to obtain an acoustic characteristic of a sound collection environment, and sound field correction is performed on the basis of the obtained acoustic characteristic.

For example, Patent Document 1 below discloses an acoustic characteristic measuring method including: a step of acquiring an impulse response waveform of a sound wave having an audio reproduction speaker as an input source at a listening point; and a step of analyzing the impulse response waveform to determine a frequency at which a sound pressure level decreases slowly or quickly as a standing wave frequency.

### CITATION LIST

### Patent Document

PATENT DOCUMENT 1 Japanese Patent Application Laid-Open No. 2018-77317

### SUMMARY OF THE INVENTION

### Problems to be Solved by the Invention

By the way, when a human listens to a sound, the sound is not determined on the basis of an instantaneous sound pressure, but the sound is determined while capturing a change in sound on a time axis including reflection, absorption, and the like. Therefore, there is a limit to improvement in quality of sound field correction only by using an acoustic characteristic obtained using a sound pressure in a simple physical dimension as in Patent Document 1.

An object of the present disclosure is to realize more excellent sound field correction.

### Solutions to Problems

The present disclosure is, for example, an information processing apparatus including
a control unit
that converts a transfer characteristic of a sound pressure from a speaker device to a listening position into an energy characteristic, and
that calculates a correction parameter for correcting a sound field generated by an output sound of the speaker device using the converted energy characteristic.

The present disclosure is, for example, an information processing apparatus including
a control unit
that receives a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic, and
corrects the sound field using the received correction parameter and outputs a reproduced sound of an audio signal from the speaker device.

The present disclosure is, for example, an information processing system including:
a speaker device; and
an information processing apparatus including a control unit that converts a transfer characteristic of a sound pressure from a speaker device to a listening position into an energy characteristic, and calculates a correction parameter for correcting a sound field generated by an output sound of the speaker device using the converted energy characteristic.

The present disclosure is, for example, an information processing system including:
a speaker device; and
an information processing apparatus including a control unit that receives a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic, corrects the sound field using the received correction parameter, and outputs a reproduced sound of an audio signal from the speaker device.

The present disclosure is, for example, an information processing method including:
converting a transfer characteristic of a sound pressure from a speaker device to a listening position into an energy characteristic; and
calculating a correction parameter for correcting a sound field generated by an output sound of the speaker device using the converted energy characteristic.

The present disclosure is, for example, an information processing method including:
receiving a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic; and correcting the sound field using the received correction parameter and outputting a reproduced sound of an audio signal from the speaker device.

The present disclosure is, for example, a program for causing a computer to execute:
converting a transfer characteristic of a sound pressure from a speaker device to a listening position into an energy characteristic; and
calculating a correction parameter for correcting a sound field generated by an output sound of the speaker device using the converted energy characteristic.

The present disclosure is, for example, a program for causing a computer to execute:
receiving a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic; and
correcting the sound field using the received correction parameter and outputting a reproduced sound of an audio signal from the speaker device.

### BRIEF DESCRIPTION OF DRAWINGS

FIG. 1 is a diagram illustrating a configuration example of an information processing system.

FIG. 2 is a diagram for explaining an outline of sound field correction.

FIG. 3 is a diagram illustrating a configuration example of a characteristic measurement unit.

FIG. 4 is a graph illustrating an example of an impulse response acquired in a user use environment.

FIG. 5 is a diagram illustrating a configuration example of a correction parameter calculation unit.

FIG. 6 is a diagram illustrating an example of a band-divided impulse response.

FIG. 7 is a diagram illustrating an example of a temporal change characteristic of power in each band.

FIG. 8 is a diagram illustrating an example of a temporal change characteristic of energy in each band.

FIG. 9 is a diagram illustrating an example of a frequency characteristic of an energy difference for each integration time.

FIG. 10 is a diagram illustrating an example of an equalizer curve for correction.

FIG. 11 is a diagram for explaining an arrangement of the information processing system.

FIG. 12 is an example of a flowchart of sound field correction processing.

FIG. 13 is an example of a flowchart of characteristic measurement processing.

FIG. 14 is an example of a flowchart of correction parameter calculation processing.

FIG. 15 is a diagram illustrating an example of a frequency characteristic of acoustic energy before and after correction.

FIG. 16 is a diagram illustrating a configuration example of an information processing system.

FIG. 17 is a sequence diagram illustrating a flow example of sound field correction processing.

FIG. 18 is a diagram for explaining an arrangement of the information processing system.

FIG. 19 is an example of a flowchart of characteristic measurement processing.

### MODE FOR CARRYING OUT THE INVENTION

Hereinafter, embodiments and the like of the present disclosure will be described with reference to the drawings. The description will be given in the following order.
<1. First Embodiment>
[1-1. Configuration Example of Information Processing System]
[1-2. Configuration Example of Information Processing Apparatus]
[1-3. Specific Example of Sound Field Correction Processing]
[1-4. Effects]
<2. Second Embodiment>
[2-1. Configuration Example of Information Processing System]
[2-2. Specific Example of Sound Field Correction Processing]
[2-3. Effects]
<3. Modifications>

### 1. First Embodiment

### [1-1. Configuration Example of Information Processing System]

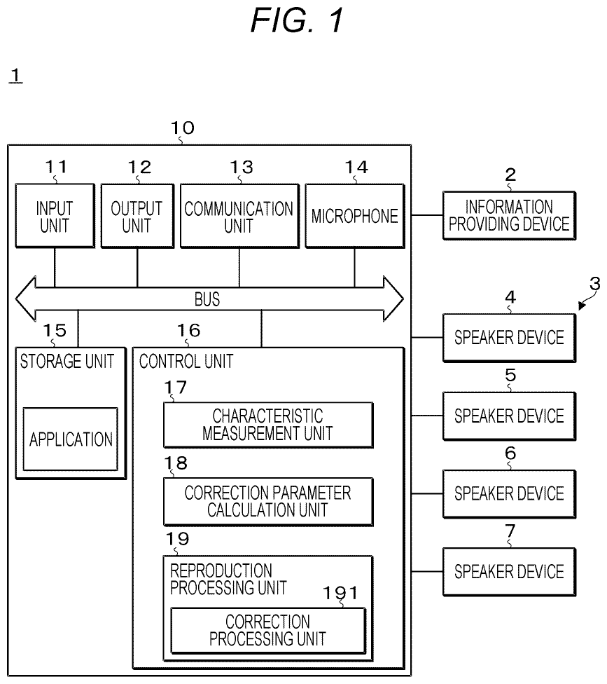

FIG. 1 illustrates a configuration example of an information processing system according to a first embodiment of the present disclosure. An information processing system 1 illustrated in FIG. 1 realizes a sound field suitable for a user. The information processing system 1 is, for example, a home theater system. The information processing system 1 includes an information providing device 2, an acoustic output device 3, and an information processing apparatus 10.

The information providing device 2 is a device connected to the information processing apparatus 10 and capable of transmitting an audio signal to the information processing apparatus 10. The information providing device 2 includes, for example, a television receiver. Note that the information providing device 2 may be a music player, a recording/reproducing device, a set top box, a game machine, a video camera, a personal computer, a mobile terminal device, or the like. The information providing device 2 is connected to the information processing apparatus 10 in a wired manner by, for example, an HDMI (registered trademark) cable or the like. Note that this connection may be, for example, wireless connection using Wi-Fi (registered trademark) or the like.

The acoustic output device 3 includes a plurality of speakers. Specifically, the acoustic output device 3 includes four speaker devices: a front left (FL channel) speaker device 4, a front right (FR channel) speaker device 5, a rear left (RL channel) speaker device 6, and a rear right (RR channel) speaker device 7. Each of the speaker devices 4 to 7 has, for example, a structure in which a predetermined number, types, and orientations of speakers are mounted in one housing. Each of the speaker devices 4 to 7 is, for example, a wireless speaker, and is wirelessly connected to the information processing apparatus 10 by Bluetooth (registered trademark) or the like. Note that this connection may be a wired connection using a predetermined speaker cable.

### [1-2. Configuration Example of Information Processing Apparatus]

The information processing apparatus 10 is an apparatus that processes an audio signal and functions as a controller that controls the entire system. The information processing apparatus 10 includes an input unit 11, an output unit 12, a communication unit 13, a microphone 14, a storage unit 15, and a control unit 16, and functions as a computer. The units constituting the information processing apparatus 10 are interconnected via a bus as illustrated, for example.

The input unit 11 is a device that inputs various types of information to the information processing apparatus 10. The input unit 11 includes, for example, a button, a switch, and the like. Note that the input unit 11 may include a device such as a touch panel, a touch screen, a keyboard, or a mouse. When the user performs an input operation on the input unit 11, a control signal corresponding to the input is generated and output to the control unit 16.

The output unit 12 is a device that outputs various types of information from the information processing apparatus 10. The output unit 12 includes, for example, a display lamp, a buzzer, and the like. The output unit 12 may include a device such as a built-in speaker or a display. For example, an example of the information processing apparatus 10 having a built-in speaker is a sound bar. The output unit 12 is controlled according to the processing of the control unit 16.

The communication unit 13 is a device that communicates with another device according to a predetermined communication standard. Examples of the predetermined communication standard include HDMI (registered trademark), universal serial bus (USB), Wi-Fi (registered trademark), Bluetooth (registered trademark), and Ethernet (registered trademark). Note that the communication method in the communication unit 13 may be other than this. Furthermore, the communication unit 13 may have a communication function (for example, infrared communication) for a predetermined remote controller (remote controller). As a result, the information processing apparatus 10 can be configured to be operable by a remote controller (not illustrated).

The information processing apparatus 10 transmits and receives audio signals to and from the information providing device 2 using, for example, HDMI (registered trademark). Furthermore, the information processing apparatus 10 updates software including an application (application program) using, for example, USB, Wi-Fi (registered trademark), or the like. Furthermore, the information processing apparatus 10 wirelessly connects the speaker devices 4 to 7 using, for example, Bluetooth (registered trademark).

The microphone 14 is a microphone incorporated in the information processing apparatus 10. Note that the microphone 14 may be an external microphone connected to the information processing apparatus 10 in a wired or wireless manner via the communication unit 13.

The storage unit 15 stores various types of information, and includes, for example, a random access memory (RAM) and a read only memory (ROM) as main storage devices, and a flash memory as an auxiliary storage device. The ROM stores a program and the like read and operated by the control unit 16. The RAM is used as a work memory of the control unit 16. The flash memory stores, for example, an application, various data used in processing of the application, and the like. Note that the auxiliary storage device may include a solid state drive (SSD), a hard disk drive (HDD), or the like. Furthermore, the storage unit 15 may use a detachable external memory connected to the information processing apparatus 10 via the communication unit 13 in a wired or wireless manner. Examples of the external memory include an optical disk, a magnetic disk, a semiconductor memory, an SSD, an HDD, and a cloud storage. In this case, the above-described application and various data may be stored in an external memory. Note that the application includes not only a program that executes all of a series of processes (for example, a program that executes sound field correction processing and reproduction processing to be described later.) but also a plug-in program that adds a part or all of predetermined processing (for example, sound field correction processing to be described later) to processing (for example, the reproduction processing) of an existing application.

The control unit 16 includes one or more processors. The control unit 16 includes, for example, a central processing unit (CPU), a digital signal processor (DSP), and the like. When information is input by the input unit 11, the control unit 16 performs various processes corresponding to the input information. Specifically, the control unit 16 controls the entire information processing apparatus 10 by executing various processes and issuing commands according to the program stored in the ROM. For example, the control unit 16 performs various processes by reading and executing an application stored in the storage unit 15. Specifically, the control unit 16 includes a characteristic measurement unit 17, a correction parameter calculation unit 18, and a reproduction processing unit 19, and performs sound field correction processing of correcting the sound field in the user use environment.

The characteristic measurement unit 17 measures a transfer characteristic (specifically, an impulse response) of the sound pressure from each of the speaker devices 4 to 7 to the viewing position of the user, that is, the listening position (listening point) as the characteristic of the installation environment of the information processing system 1. Note that the listening position includes one assumed to be the listening position in acoustic design described later. The correction parameter calculation unit 18 calculates a correction parameter using the characteristic measured by the characteristic measurement unit 17. The reproduction processing unit 19 reproduces an audio signal input from the information providing device 2 or the like to the information processing apparatus 10, and causes each of the speaker devices 4 to 7 to output a reproduced sound of the audio signal. Note that the reproduction processing unit 19 includes a correction processing unit 191.

The correction processing unit 191 corrects the sound field generated by the output sound of each of the speaker devices 4 to 7 using the correction parameter calculated by the correction parameter calculation unit 18. Specifically, the sound field is corrected by adjusting the frequency characteristic of the audio signal output to each of the speaker devices 4 to 7. That is, the sound field correction is performed by adjusting the reproduced sound of each of the speaker devices 4 to 7.

The correction processing unit 191 includes an equalizer (EQ) module of an infinite impulse response (IIR) filter as a processing block. Specifically, the equalizer module is of 8 bands having a center frequency of 63 Hz, 125 Hz, 250 Hz, 500 Hz, 1 kHz, 2 kHz, 4 kHz, and 8 kHz in a 1/1 octave band. Note that settings of the number of bands, each bandwidth, the center frequency, and the like can be optionally set according to a user instruction using the input unit 11 or the like. Thus, the output sound of each of the speaker devices 4 to 7 can be adjusted in detail.

In this manner, by configuring the correction processing unit 191 as an octave band filter for each frequency band, the amount of calculation can be reduced as compared with the case of using an octave band filter. Note that the configuration of the correction processing unit 191 is not limited thereto, and may be configured by, for example, an octave band filter or an equalizer module of a finite impulse response (FIR) filter.

### “Outline of Sound Field Correction”

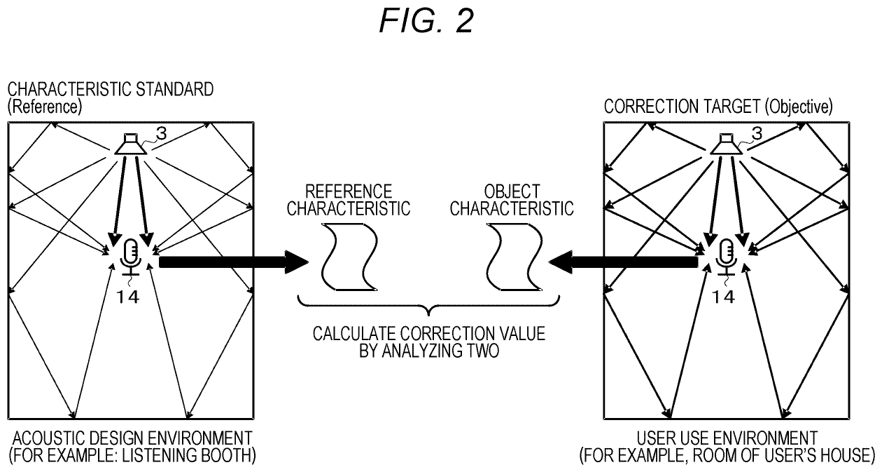

FIG. 2 is an explanatory diagram for describing an outline of sound field correction. The sound field correction according to the present embodiment corrects the acoustic characteristic in the use environment of the information processing system 1 of the user to the reference characteristic. In the information processing system 1, which is one of the acoustic systems, an acoustic engineer usually performs acoustic design. Specifically, the acoustic engineer performs final sound adjustment (sound production) in an environment suitable for sound adjustment (for example, a listening booth), and determines optimum values of various settings (for example, setting of parameters of the equalizer) of the sound adjustment. However, the actual use environment (for example, a room of the user's house) of the information processing system 1 of the user varies depending on the user, and the characteristic may be greatly different from those of the environment in which the sound is adjusted, such as a room with strong reflection or an unbalanced room. Therefore, in the sound field correction processing, the characteristic of the acoustic design environment of the information processing system 1 is set as the reference characteristic (characteristic standard: ref), the characteristic of the user use environment of the information processing system 1 is set as the object characteristic (correction target: obj), and these two characteristics are used.

For example, as illustrated in the drawing, the reference characteristic is measured by outputting a measurement sound for characteristic measurement from the acoustic output device 3 in the acoustic design environment and collecting the measurement sound with the microphone 14. The measured reference characteristic is measured and processed in advance and stored in the storage unit 15 or the like, so that the correction parameter calculation unit 18 can refer to the reference characteristic. On the other hand, the measurement of the object characteristic is performed by causing the user to execute sound field correction processing to be described later in the use environment so that the measurement sound is output from the acoustic output device 3 in the use environment of the information processing system 1 and collected and measured by the microphone 14. The correction parameter calculation unit 18 calculates the correction parameter by analyzing these two characteristics. This is hereinafter described in detail.

### “Configuration Example of Characteristic Measurement Unit”

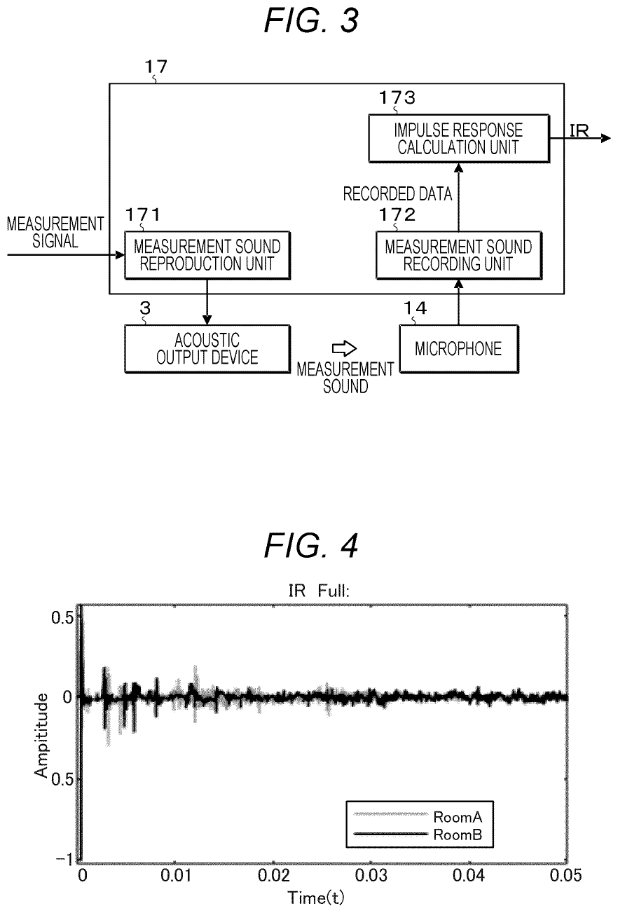

FIG. 3 illustrates a configuration example of the characteristic measurement unit 17. The characteristic measurement unit 17 includes a measurement sound reproduction unit 171, a measurement sound recording unit 172, and an impulse response calculation unit 173. The measurement sound reproduction unit 171 acquires the measurement signal (for example, a log sweep signal), reproduces the acquired measurement signal, and outputs the measurement sound based on the measurement signal from the speaker device (any one of the speaker devices 4 to 7) of the correction target channel of the acoustic output device 3. For example, the measurement signal stored in advance in the storage unit 15 is read and acquired.

The measurement sound recording unit 172 collects and records the measurement sound with the microphone 14. The impulse response calculation unit 173 calculates the impulse response (IR) using the measurement sound (recorded data) recorded by the measurement sound recording unit 172. The impulse response calculation unit 173 calculates an impulse response by synchronously adding measurement sounds by, for example, the sweep pulse method. Specifically, the impulse response is a room impulse response (RIR). Note that the method of measuring the impulse response may be other than this. For example, other signals such as an impulse signal, a time stretched pulse (TSP) signal, and a maximum length sequence (M-sequence) signal may be used as the measurement signal. The impulse response (IR) calculated by the impulse response calculation unit 173 is input to the correction parameter calculation unit 18 (see FIG. 1).

FIG. 4 illustrates an example of an impulse response (entire band) acquired in the user use environment. In FIG. 4, a thin waveform line represented by “RoomA” indicates a characteristic in an acoustic design environment using the speaker device 4, and a dark waveform line represented by “RoomB” indicates a characteristic in a user use environment using the speaker device 4. The similarity applies to the following drawings.

### “Configuration Example of Correction Parameter Calculation Unit”

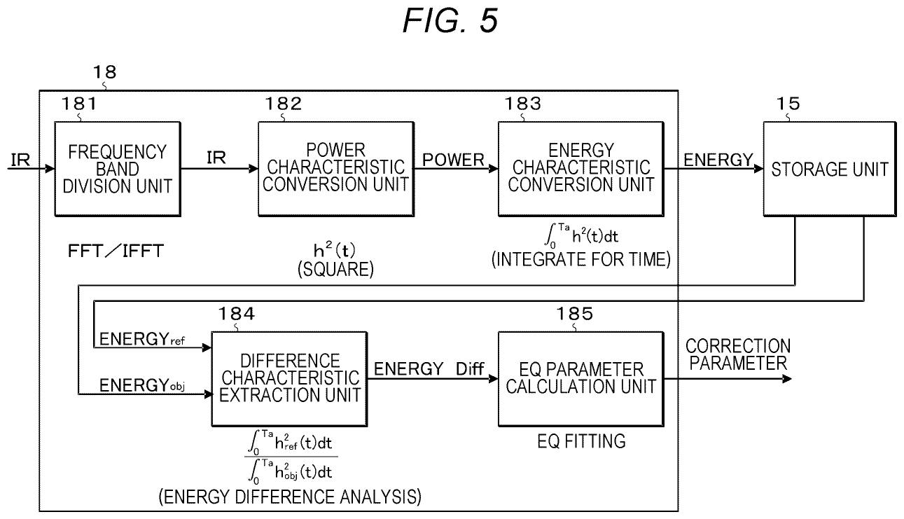

FIG. 5 illustrates a configuration example of the correction parameter calculation unit 18. The correction parameter calculation unit 18 includes a frequency band division unit 181, a power characteristic conversion unit 182, an energy characteristic conversion unit 183, a difference characteristic extraction unit 184, and an EQ parameter calculation unit 185.

The frequency band division unit 181 divides the input impulse response (IR) into a predetermined number (m) of frequency bands and converts the divided impulse response (IR) into band-divided impulse responses (IR). Specifically, the frequency band division unit 181 divides the impulse response into bands in accordance with the equalizer module constituting the correction processing unit 191. The frequency band division unit 181 obtains a band-divided impulse response using, for example, Fast Fourier Transform (FFT)/Inverse Fast Fourier Transform (IFFT). Note that the frequency band may be divided by other methods.

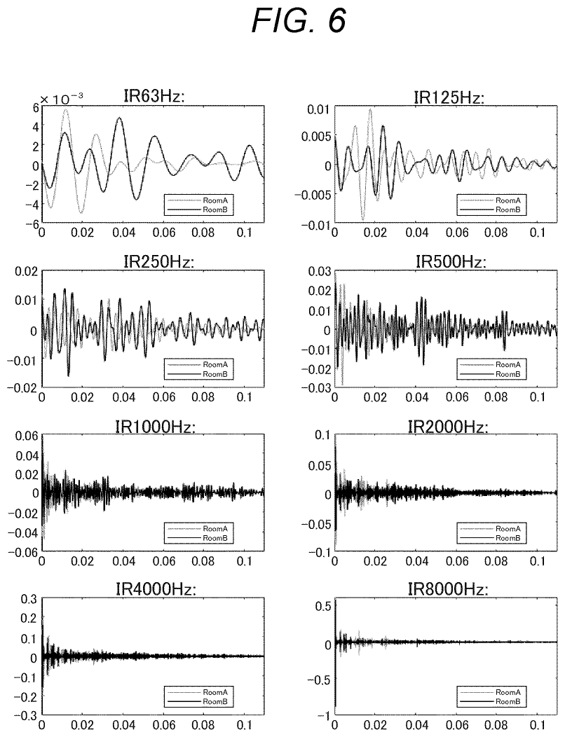

FIG. 6 illustrates an example of a band-divided impulse response (impulse response of each band). The impulse response illustrated in FIG. 6 illustrates a case (m=8) in which the frequency band of the input impulse response (IR) is decomposed with the resolution of 1/1 octave band and the center frequency is set to 63 Hz, 125 Hz, 250 Hz, 500 Hz, 1 kHz, 2 kHz, 4 kHz, and 8 KHz. Note that the division conditions such as the predetermined number (m), each bandwidth, and the center frequency can be optionally set (for example, finer ⅓ octave band, etc.) according to a user instruction using the input unit 11 or the like. As a result, the sound field can be corrected in detail.

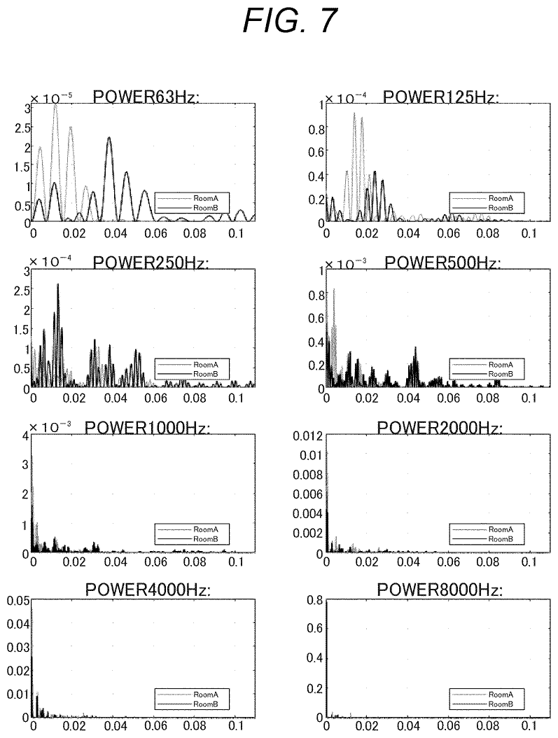

The power characteristic conversion unit 182 converts an impulse response into a power characteristic. Specifically, the power characteristic conversion unit 182 converts a predetermined number (m) of impulse responses (IR) band-divided by the frequency band division unit 181 into temporal change characteristics of power. Specifically, the power characteristic conversion unit 182 obtains the temporal change characteristic (POWER) of power by the square (h²(t)) of the impulse response function h(t). FIG. 7 illustrates an example of a temporal change characteristic of power in each band.

The energy characteristic conversion unit 183 converts a power characteristic into an energy characteristic. Specifically, the energy characteristic conversion unit 183 converts each of the temporal change characteristics (POWER) of the predetermined number (m) of power obtained by the power characteristic conversion unit 182 into a temporal change characteristic of energy.

The acoustic energy in the energy characteristic can be obtained by squaring the sound pressure to obtain power, integrating the power with a desired time Ta, and converting the power into a unit called energy. The acoustic energy is an energy amount [J/m²] of sound flowing in a unit area. In other words, the acoustic energy is energy up to a time point at which a certain time elapses after sound is emitted. Acoustic energy E can be obtained by the following equation (1), where the sound pressure is P (variation [Pa] from the atmospheric pressure due to sound), the air density is p, and the sound speed is c. Note that, in a special area where the air density changes, such as high ground, it is preferable to introduce variables such as the air density p and the sound speed c so as to perform detailed sound field correction, but otherwise, these variables may be constants.

$$\begin{matrix}[ Math . 1 ] & \\ E = \int \frac{1}{ρ c} {p}^{2} ( t ) dt & ( 1 )\end{matrix}$$

On the basis of this equation (1), the energy characteristic conversion unit 183 obtains the temporal change characteristic (POWER) of energy by integrating the temporal change characteristics (ENERGY) of the predetermined number (m) of power obtained by the power characteristic conversion unit 182 at the desired time Ta. Specifically, the energy characteristic conversion unit 183 calculates a characteristic with a predetermined number (n) of times Ta. The time Ta and the predetermined number (n) of values can be optionally set according to a user instruction using the input unit 11 or the like. As a result, the time Ta can be optimized. The characteristic (ENERGY) obtained in this manner is stored in the storage unit 15 or the like and used by the difference characteristic extraction unit 184.

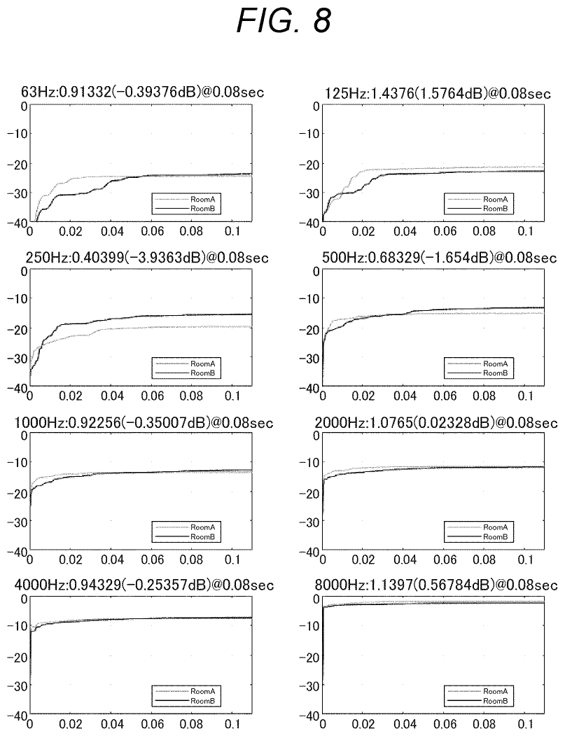

FIG. 8 illustrates an example of a temporal change characteristic of energy. Note that “0.91332 (−0.39376 dB) @0.08 sec” in the graph at 63 Hz (the top graph on the left) in FIG. 8 indicates the difference oo (oo) in the case of Ta=80 ms. The similarity applies to graphs of other bands.

The difference characteristic extraction unit 184 analyzes the energy difference between the temporal change characteristic of energy calculated from the reference characteristic (reference energy characteristic) and the temporal change characteristic of energy calculated from the object characteristic. Specifically, the difference characteristic extraction unit 184 calculates information (ENERGY Diff) indicating the frequency characteristic of the energy difference with reference to the temporal change characteristic (ENERGYref) of energy in the acoustic design environment and the temporal change characteristic (ENERGYobj) of energy in the user use environment stored in the storage unit 15.

Note that the temporal change characteristic (ENERGYobj) of energy in the user use environment may be directly received from the energy characteristic conversion unit 183 without passing through the storage unit 15. Furthermore, the temporal change characteristic (ENERGYref) of energy in the acoustic design environment may be acquired from another device using the communication unit 13. Note that this characteristic (ENERGYref) may be obtained by storing the impulse response measured in the acoustic design environment in the storage unit 15 or the like and converting the impulse response into the temporal change characteristic of the read energy.

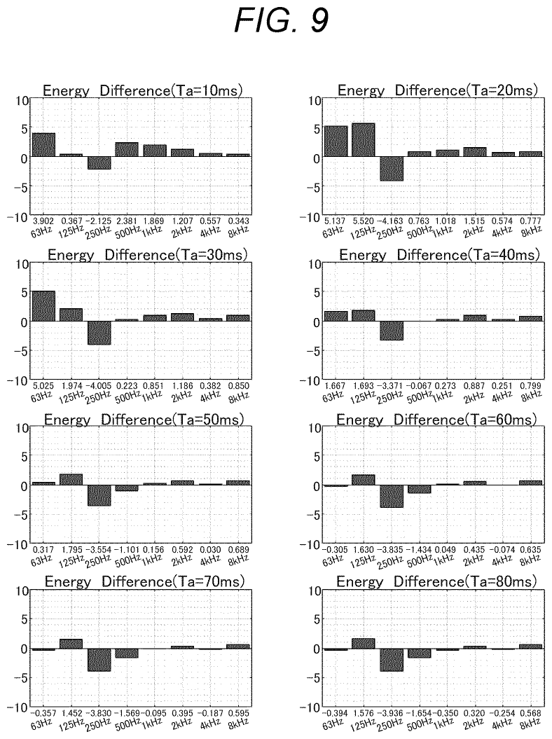

FIG. 9 illustrates an example of the frequency characteristic of the energy difference for each time Ta. In the example illustrated in FIG. 9, eight characteristics (n=8) of Ta=10 ms, 20 ms, 30 ms, 40 ms, 50 ms, 60 ms, 70 ms, and 80 ms are calculated. It can be seen from FIG. 9 that the frequency characteristics vary depending on the value of the integration time Ta.

The EQ parameter calculation unit 185 calculates a correction parameter of an equalizer module constituting the correction processing unit 191. The EQ parameter calculation unit 185 performs equalizer fitting using the frequency characteristic of the energy difference obtained by the difference characteristic extraction unit 184, and calculates a correction parameter. More specifically, the EQ parameter calculation unit 185 compares the optimum value of the acoustic energy at the time of acoustic design with the value obtained by measurement under the user use environment, and calculates the correction parameter with the same value. As a result, correction in consideration of the temporal axis change is performed.

Specifically, the EQ parameter calculation unit 185 causes the frequency characteristic of the acoustic energy in the user use environment to match with the frequency characteristic of the acoustic energy in the acoustic design environment. A relational expression of the acoustic energy from 0 (seconds) to the time Ta for each band can be expressed by the following equation (2).

$$\begin{matrix}[ Math . 2 ] & \\ {\int }_{0}^{{T}_{a}} \frac{1}{ρ c} {p}_{Ref\_xx}^{2} ( t ) dt = {k}_{xx} {\int }_{0}^{{T}_{a}} \frac{1}{ρ c} {p}_{Obj\_xx}^{2} ( t ) dt & ( 2 )\end{matrix}$$

The left side of the equation (2) represents the acoustic energy in the acoustic design environment, and the right side represents the acoustic energy in the user use environment and its coefficient Kxx. The coefficient Kxx is a coefficient for matching the acoustic energy in the use environment with the acoustic energy in the acoustic design environment. The EQ parameter calculation unit 185 obtains the correction coefficient Kxx with which both sides match in the equation (2). That is, the EQ parameter calculation unit 185 acquires the temporal change characteristic (ENERGYref) of energy in the acoustic design environment, calculates the correction coefficient Kxx that matches the acoustic energy of the temporal change characteristic (ENERGYobj) of energy converted from the object characteristic with the acoustic energy of the temporal change characteristic of energy in the acoustic design environment, and calculates the correction parameter using the calculated correction coefficient Kxx.

The time Ta used for calculation of the correction coefficient can be set to an arbitrary value for each frequency band. For example, by providing an octave band filter, a correction coefficient can be obtained for each frequency band. As a result, the EQ parameter calculation unit 185 can calculate the correction coefficient using the time Ta optimized for each frequency band so that the low sound and the clarity are improved. The EQ parameter calculation unit 185 applies the correction coefficient Kxx to the equalizer curve set as the optimum value to obtain the equalizer curve for correction, and calculates the correction parameter for each frequency band.

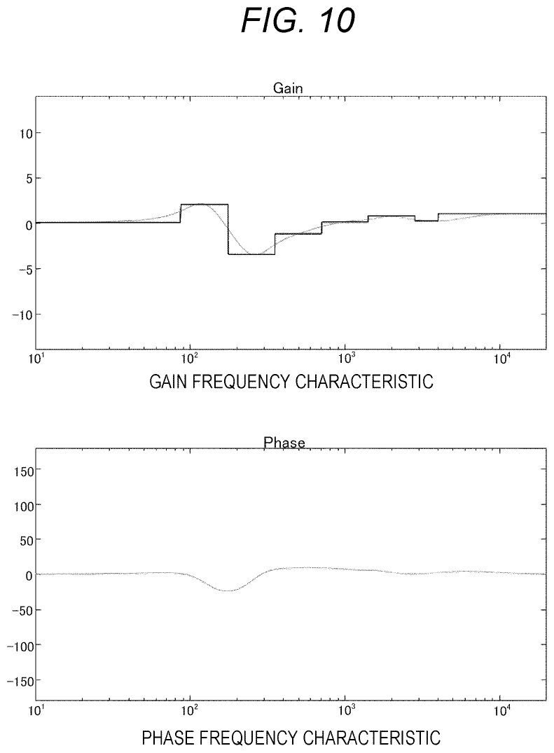

FIG. 10 illustrates an example of the equalizer curve for correction. The equalizer curve (the gain frequency characteristic and the phase frequency characteristic) for correction illustrated in FIG. 10 finally becomes information (correction parameter) used for correction.

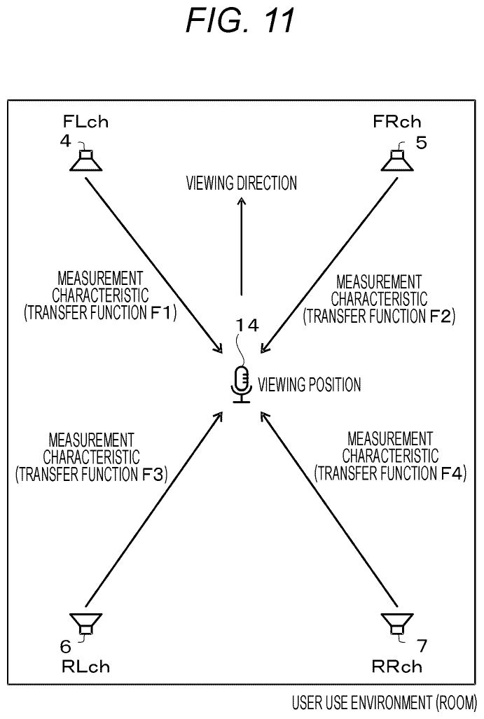

Note that calculation of the correction parameter can be optionally selected from a case where the correction parameter is individually calculated in each channel and a case where the correction parameter is calculated by channel cooperation in accordance with a user instruction using the input unit 11 or the like. In the case of individual calculation, as illustrated in FIG. 11, for example, the correction gain of the FL channel (ch) is calculated from the transfer function F1 between the speaker device 4 and the microphone 14. Similarly, the correction gain of the FR channel is calculated from the transfer function F2 between the speaker device 5 and the microphone 14. The correction gain of the RL channel is calculated from the transfer function F3 between the speaker device 6 and the microphone 14. The correction gain of the RR channel is calculated from the transfer function F4 between the speaker device 7 and the microphone 14.

On the other hand, in the case of calculation by channel cooperation, each of the correction parameters is calculated by an average value of a calculated value using a transfer function specified by a transfer characteristic for the speaker device to be corrected with the correction parameter to be calculated and a calculated value using a transfer function specified by a transfer characteristic for another speaker device cooperating with the speaker device.

For example, in a case where the L channel and the R channel are cooperatively calculated from the LR average value, the correction gain of the FL channel is calculated from the average value using the transfer function F1 and the transfer function F2. Similarly, an average value of the correction gain of the FR channel is calculated using the transfer function F1 and the transfer function F2. An average value of the correction gain of the RL channel is calculated using the transfer function F3 and the transfer function F4. An average value of the correction gain of the RR channel is calculated using the transfer function F3 and the transfer function F4. In the case of music reproduction, there are many cases where related signals are included in the L channel and the R channel. Therefore, averaging the correction values with the LR as described above can suppress a change in the loudness feeling or a change in the localization feeling in the L and R channels rather than individually and optimally correcting the signals. In addition, qualitative evaluation such as improvement in clarity and low sound feeling can be increased in music reproduction.

### [Configuration Example of Reproduction Processing Unit]

The reproduction processing unit 19 illustrated in FIG. 1 reproduces the audio signal input to the information processing apparatus 10, and outputs reproduced sound from each of the speaker devices 4 to 7. The correction processing unit 191 performs acoustic energy correction processing using the correction parameter calculated by the correction parameter calculation unit 18. Specifically, the correction processing unit 191 sets the setting of the equalizer constituting the correction processing unit 191 to the correction parameter calculated by the EQ parameter calculation unit 185. As a result, the frequency characteristic of the acoustic energy of the reproduced sound of each of the speaker devices 4 to 7 is corrected, and the sound field correction is realized.

### [1-3. Specific Example of Sound Field Correction Processing]

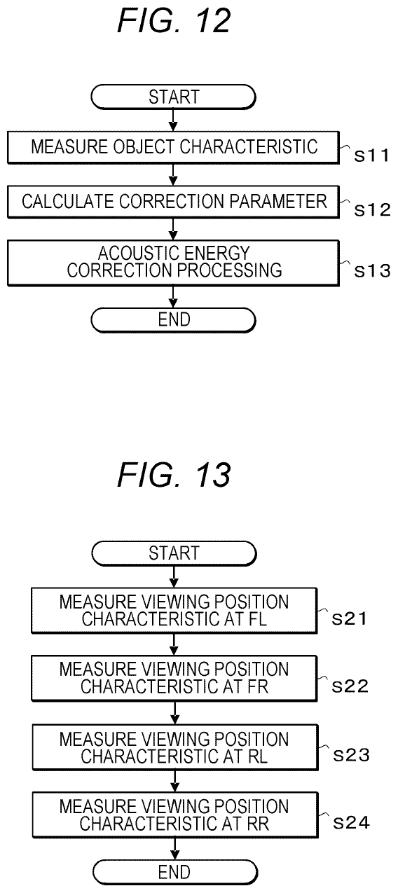

FIG. 12 illustrates an example of a flowchart of the sound field correction processing. The sound field correction processing is performed, for example, as a base of a key algorithm, and is executed at the time of initial setting of the information processing system 1. Note that the sound field correction processing may be periodically executed, executed every time a user instruction is issued, or the like. Alternatively, the measurement signal may be included in the audio signal and executed in real time when the audio signal is reproduced.

When the sound field correction processing is started, first, the control unit 16 performs the characteristic measurement processing by the characteristic measurement unit 17 and measures the object characteristic (step S11). Note that, as illustrated in FIG. 11, this measurement is executed in a state where the microphone 14 is installed at the user's viewing position and the speaker devices 4 to 7 are installed in the actual viewing environment (position and orientation). Specifically, the speaker device 4 is disposed on the front left side of the viewing position, the speaker device 5 is disposed on the front right side, the speaker device 6 is disposed on the rear left side, and the speaker device 7 is disposed on the rear right side.

FIG. 13 illustrates an example of a flowchart of the characteristic measurement processing. In the characteristic measurement processing, the control unit 16 measures the characteristic of the viewing position using the measurement sound of the speaker device 4 of the FL channel (step S21), and measures the characteristic at the viewing position using the measurement sound of the speaker device 5 of the FR channel (step S22). Further, the characteristic at the viewing position using the measurement sound of the speaker device 6 of the RL channel is measured (step S23), and the characteristic at the viewing position using the measurement sound of the speaker device 7 of the RR channel is measured (step S24). This ends the characteristic measurement processing. Note that the measurement in steps S21 to S24 is continuously performed in a series of sequences. For example, when the user taps the measurement start button, the measurement is performed non-stop until the measurement in steps S21 to S24.

Then, as illustrated in FIG. 12, when the characteristic measurement processing ends, the control unit 16 performs correction parameter calculation processing to calculate a correction parameter (step S12).

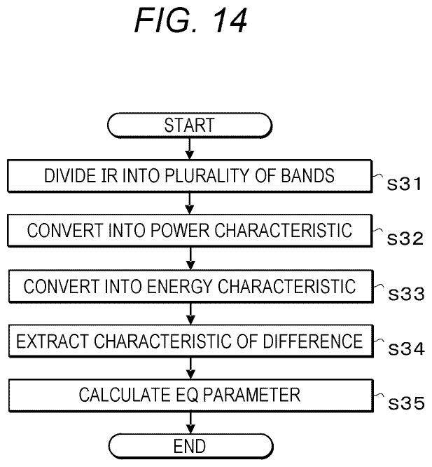

FIG. 14 illustrates an example of a flowchart of the correction parameter calculation processing. In the correction parameter calculation processing, first, the frequency band division unit 181 divides the four characteristics (impulse responses) measured by the characteristic measurement unit 17 in step S11 into a predetermined number (m) of frequency bands (step S31). Next, the power characteristic conversion unit 182 converts each characteristic divided into the frequency bands into a temporal change characteristic of power (step S32). Subsequently, the energy characteristic conversion unit 183 converts the temporal change characteristic of power into the temporal change characteristic of energy (step S33).

Then, the difference characteristic extraction unit 184 calculates the frequency characteristic of the energy difference using the temporal change characteristic of energy (temporal change characteristic of the energy by the object characteristic) and the temporal change characteristic of energy by the reference characteristic stored in the storage unit 15 or the like (step S34).

Note that the temporal change characteristic of energy by the reference characteristic is calculated similarly to the temporal change characteristic of energy by the object characteristic using the reference characteristic measured in the acoustic design environment. The reference characteristic is measured similarly to the object characteristic, for example, by arranging the microphone 14 and each of the speaker devices 4 to 7 at positions and orientations suitable for sound adjustment. At this time, for example, the microphone 14 is arranged at a position where the user viewing position is assumed.

Next, the EQ parameter calculation unit 185 calculates a correction parameter using the difference frequency characteristic of energy (step S35). The correction parameter calculation processing ends.

Then, as illustrated in FIG. 12, when the correction parameter calculation processing ends, the control unit 16 performs acoustic energy correction processing by the correction processing unit 191 (step S13), and ends the sound field correction processing. As a result, the sound field generated by the reproduced sound output from each of the speaker devices 4 to 7 is corrected.

### [1-4. Effects]

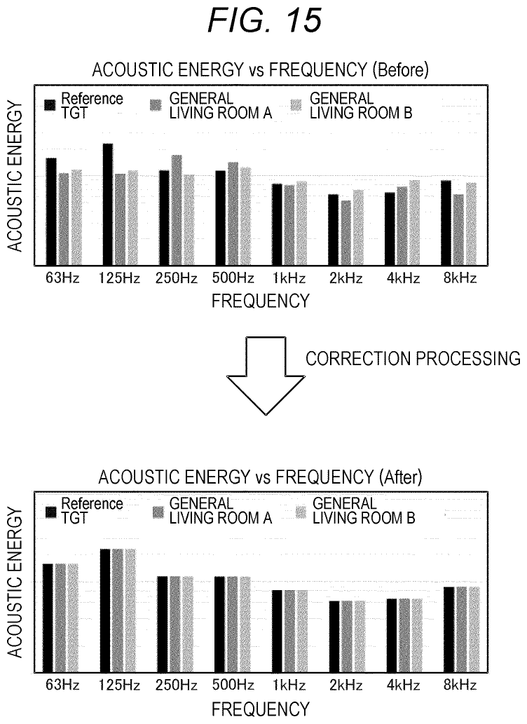

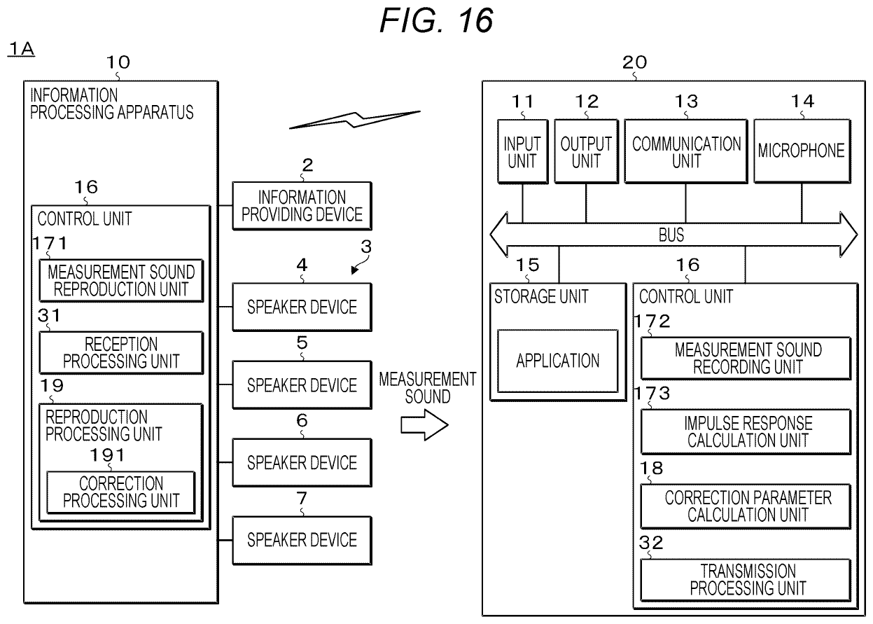

FIG. 15 illustrates an example of a frequency characteristic of acoustic energy before and after correction. The darkest graph indicates the acoustically designed characteristic (reference target: ideal acoustic energy), the next lighter graph indicates the characteristic of a first viewing environment (general living room A) of the user (acoustic energy to be first corrected), and the lightest graph indicates the characteristic of a second viewing environment (general living room B) of the user (acoustic energy to be second corrected).

Before the correction processing, the value of the acoustic energy is different in each frequency band, but after the correction processing, it can be seen that the values are all matched with the values of the ideal graph shown most darkly. In this manner, the acoustic energy characteristic of the user use environment can be matched with the acoustic energy characteristic of the acoustic design environment. Note that the user may select and correct the band to be corrected (or the band not to be corrected) without correcting the entire band. As a result, for example, processing efficiency can be improved by omitting processing in a band that is not much different between the acoustic design environment and the user use environment.

As described above, the information processing apparatus 10 calculates the acoustic energy and calculates the correction parameter used for the sound field correction using the calculated acoustic energy. The acoustic energy is not a simple sound pressure but is a characteristic in consideration of (a change due to) the characteristic on the time axis. As a result, reverberation components such as reflection and sound absorption are also corrected. Furthermore, it is possible to control how much reflection and reverberation components in the viewing environment are added and corrected by the value of the time Ta described above. As described above, when a human listens to sound, the sound is regarded as sound including reverberation. Therefore, it is possible to realize sound field correction with higher sound quality (improvement of audible evaluation) than conventional sound field correction by aligning the sound including reverberation as an ideal target.

For example, in a case where the acoustic energy in the user viewing environment is large, reverberation is large. In this case, the correction coefficient Kxx is a value that acts in a direction of suppressing reverberation. The acoustic design environment usually has high sound absorbency so that differences in sound can be identified. For example, in a case where the reverberation is adjusted to be suppressed in the acoustic design environment, the reverberation is suppressed by the acoustic energy correction, and the low sound and the clarity can be improved. That is, more appropriate correction can be performed in a space with many reflections. Note that, on the contrary, reverberation can be added according to adjustment in the acoustic design environment. Sound field optimization can be achieved by correcting the acoustic energy to match the acoustic design environment.

### 2. Second Embodiment

Next, a second embodiment of the present disclosure will be described. Note that, in the following description and the drawings, components having functions, configurations, or steps similar to those of the first embodiment are denoted by the same reference numerals, only differences are described, and redundant description is omitted.

### [2-1. Configuration Example of Information Processing System]

FIG. 16 illustrates a configuration example of an information processing system according to a second embodiment of the present disclosure. An information processing system 1A illustrated in FIG. 16 includes an information providing device 2, an acoustic output device 3 (including speaker devices 4 to 7), an information processing apparatus 10, and an information processing apparatus 20, and performs sound field correction in cooperation between the information processing apparatus 10 on the reception side and the information processing apparatus 20 on the transmission side.

The information processing apparatus 10 on the reception side is different from the information processing apparatus 10 of the first embodiment in the configuration of the control unit 16. The other configurations are basically the same. The control unit 16 of the information processing apparatus 10 on the reception side includes the measurement sound reproduction unit 171 and the reproduction processing unit 19 (including the correction processing unit 191) described above, and a reception processing unit 31. Note that the storage unit 15 of the information processing apparatus 10 on the reception side stores an application that performs processing of the information processing apparatus 10 on the reception side described below.

The reception processing unit 31 performs reception processing of receiving the correction parameter transmitted by the information processing apparatus 20 on the transmission side. For example, the information processing apparatus 10 on the reception side may have a configuration in which the reception processing unit 31 is added to the information processing apparatus 10 of the first embodiment, and the user may select whether or not to cooperate with the information processing apparatus 20 on the transmission side. This can improve user convenience.

The information processing apparatus 20 on the transmission side is connected to the information processing apparatus 10 on the reception side and cooperates with the information processing apparatus 10 on the reception side. The information processing apparatus 10 on the reception side and the information processing apparatus 20 on the transmission side are wirelessly connected by, for example, Wi-Fi (registered trademark), Bluetooth (registered trademark), or the like. Note that this connection may be a wired connection using a predetermined connection cable.

The information processing apparatus 20 on the transmission side includes the input unit 11, the output unit 12, the communication unit 13, the microphone 14, the storage unit 15, and the control unit 16 described above, and functions as a computer. Specifically, the information processing apparatus 20 on the transmission side is a smartphone, and the microphone 14 is a built-in microphone of the smartphone. The storage unit 15 of the information processing apparatus 20 on the transmission side stores an application of a smartphone that performs processing of the information processing apparatus 20 on the transmission side described below. Note that the information processing apparatus 20 on the transmission side is not limited thereto, and may be a portable information terminal (for example, a tablet terminal, a notebook computer, a head mounted display, or a game controller) or the like.

The control unit 16 of the information processing apparatus 20 on the transmission side includes the measurement sound recording unit 172, the impulse response calculation unit 173, and the correction parameter calculation unit 18 described above, and a transmission processing unit 32. The transmission processing unit 32 performs transmission processing of transmitting the correction parameter received by the information processing apparatus 10 on the reception side.

### [2-2. Specific Example of Sound Field Correction Processing]

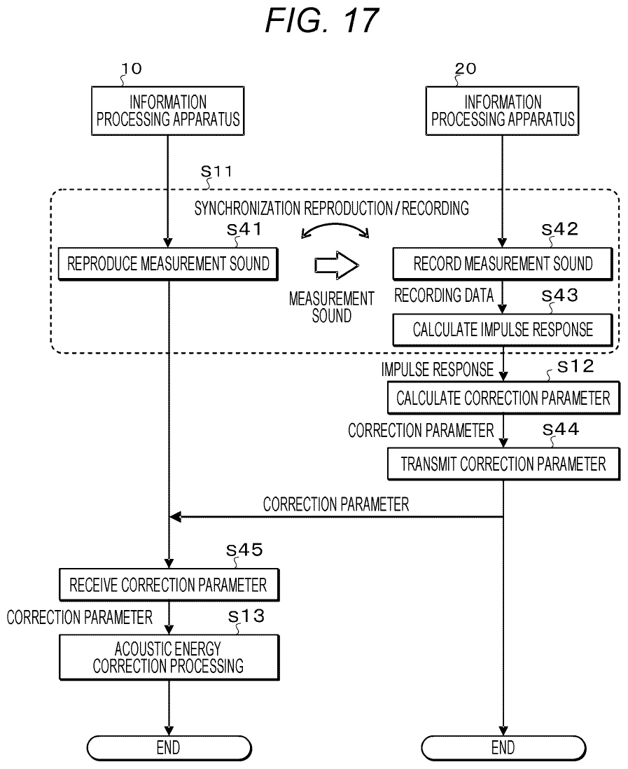

FIG. 17 is a sequence diagram illustrating a flow example of sound field correction processing in the information processing system 1A. When the sound field correction processing is started, first, the control units 16 of the information processing apparatus 10 on the reception side and the information processing apparatus 20 on the transmission side cooperate to perform the characteristic measurement processing and measure the object characteristic (step S11).

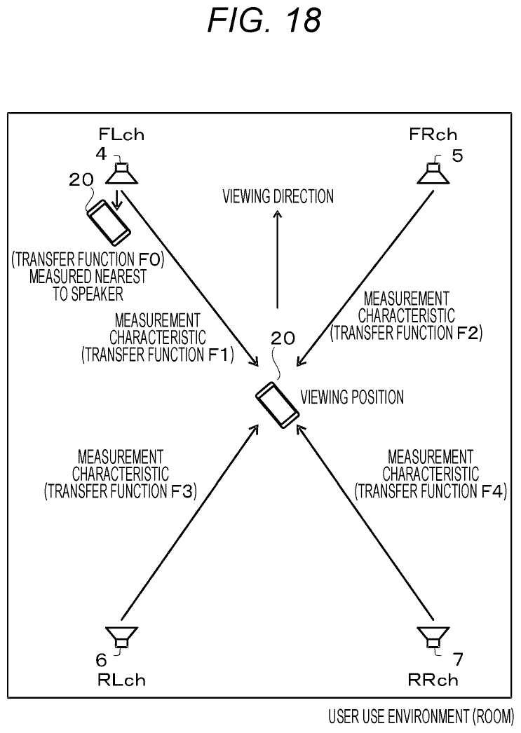

Note that, in the information processing system 1A, characteristic measurement is performed in two types. As illustrated in FIG. 18, the first type of measurement is a measurement for detecting a characteristic of a built-in microphone of the smartphone, and measures the characteristic in a state where the microphone 14 (built-in microphone of the smartphone) of the information processing apparatus 20 on the transmission side is arranged at a nearest position of the speaker device 4. The second type of measurement is a measurement for detecting the viewing environment characteristic at the viewing position, and measures the characteristic in a state where the microphone 14 (built-in microphone of the smartphone) of the information processing apparatus 20 on the transmission side is arranged at the viewing position in order to acquire the characteristic at the viewing position including the influence of the viewing environment. The second type of measurement is the same as the measurement of the first embodiment.

The frequency characteristic of the built-in microphone of the smartphone varies depending on the model of the smartphone. Therefore, if correction is performed using the collected sound data collected by the built-in microphone of the smartphone as it is, a correction error occurs. Therefore, by performing the characteristic measurement by the characteristic measurement processing separately in two in this manner, it is possible to estimate the frequency characteristic of the built-in microphone of the smartphone and correct the measurement result at the viewing position.

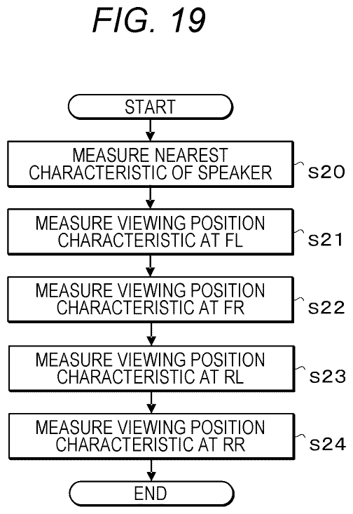

FIG. 19 illustrates an example of a flowchart of characteristic measurement processing executed by the information processing system 1A. In this characteristic measurement processing, first, the transfer characteristic (impulse response) of the sound pressure from the speaker device 4 to a nearest position of the speaker device 4 is measured (step S20). Then, similarly to the first embodiment, the characteristics at the viewing positions using the speaker devices 4 to 7 are measured (steps S21 to S24), and the characteristic measurement processing ends.

Measurement of each characteristic is performed as illustrated in FIG. 17. First, the control unit 16 of the information processing apparatus 10 on the reception side acquires the measurement signal by the measurement sound reproduction unit 171, and reproduces the acquired measurement signal (step S41). As a result, the measurement sound is output from the speaker device to be measured.

On the other hand, the control unit 16 of the information processing apparatus 20 on the transmission side causes the measurement sound recording unit 172 to collect and record the measurement sound using its own microphone 14 (built-in microphone of the smartphone) (step S42). This recording is performed, for example, in synchronization with reproduction of a measurement signal of the information processing apparatus 10 on the reception side.

Next, the control unit 16 of the information processing apparatus 20 on the transmission side causes the impulse response calculation unit 173 to calculate the impulse response using the measurement sound (recorded data) recorded by the measurement sound recording unit 172 (step S43).

At this time, the impulse response calculation unit 173 of the information processing apparatus 20 on the transmission side calculates the impulse response in which the frequency characteristic of the microphone 14 (built-in microphone of the smartphone) is corrected. Specifically, the difference between the transfer function F0 (see FIG. 18) specified by the transfer characteristic acquired in the first type of measurement and the transfer function F1 specified by the transfer characteristic acquired in the second type of measurement is extracted, and each of the transfer functions F1 to F4 is corrected to the characteristic of only the viewing environment characteristic using the extracted difference. As a result, it is possible to correct the measurement error of each impulse response from each of the speaker devices 4 to 7 to the listening position due to the difference in the frequency characteristic of the microphone 14 of the information processing apparatus 20 on the transmission side. Note that a device for measuring characteristics for this correction may be other than the speaker device 4.

Then, the control unit 16 of the information processing apparatus 20 on the transmission side uses the impulse response corrected by the impulse response calculation unit 173 to calculate a correction parameter by the correction parameter calculation unit 18 (step S12). Next, the control unit 16 of the information processing apparatus 20 on the transmission side causes the transmission processing unit 32 to transmit the correction parameter calculated by the impulse response calculation unit 173 to the information processing apparatus 10 on the reception side (step S44), and ends the characteristic measurement processing.

On the other hand, the control unit 16 of the information processing apparatus 10 on the reception side causes the reception processing unit 31 to receive the correction parameter transmitted by the information processing apparatus 20 on the transmission side (step S45). Subsequently, the correction processing unit 191 performs acoustic energy correction processing (step S13), and ends the sound field correction processing. As a result, the sound field generated by the reproduced sound output from each of the speaker devices 4 to 7 is corrected.

### [2-3. Effects]

As described above, since the information processing apparatus 10 on the reception side calculates the acoustic energy and calculates the correction parameter used for the sound field correction using the calculated acoustic energy, it is possible to realize sound field correction with higher sound quality than the conventional sound field correction, similarly to the first embodiment.

Furthermore, since the characteristics can be measured using the microphone 14 (built-in microphone of the smartphone) of the information processing apparatus 20 on the transmission side, it is not necessary to arrange the information processing apparatus 10 on the reception side at the viewing position. As a result, the operability of the user is improved, and the convenience can be improved.

Furthermore, since the correction parameter calculation unit 18 of the information processing apparatus 20 on the transmission side calculates the correction parameter using the characteristic obtained by correcting the frequency characteristic of the microphone 14 by the impulse response calculation unit 173, even in a case where the frequency characteristic of the microphone 14 of the information processing apparatus 20 on the transmission side is different depending on what is used by the user due to a difference in model or the like, it is possible to realize sound field correction with high sound quality.

### <3. Modifications>

Although the embodiments of the present disclosure have been specifically described above, the present disclosure is not limited to the above-described embodiments, and various modifications based on the technical idea of the present disclosure are possible. For example, various modifications to be described below can be made. Furthermore, one or a plurality of optionally selected aspects of the modifications to be described below can be appropriately combined. In addition, the configurations, methods, steps, shapes, materials, numerical values, and the like of the above-described embodiments can be combined or exchanged with each other without departing from the gist of the present disclosure. Furthermore, one may be divided into two or more, and a part thereof may be omitted.

For example, in each of the above-described embodiments, the configuration including the four speaker devices 4 to 7 has been exemplified as the acoustic output device 3, but the configuration of the acoustic output device 3 is not limited thereto. The similarity applies to the configuration of each of the speaker devices 4 to 7. The acoustic output device 3 only needs to be able to reproduce sound that creates a sound field. Furthermore, the number of output channels supported by the acoustic output device 3 is not limited to 4 channels, and may be, for example, 2.1 channels, 5.1 channels, 7.1 channels, or the like.

Furthermore, for example, the environment for measuring the reference characteristics in each of the above-described embodiments may be an environment serving as a reference of correction, and may be other than the acoustic design environment. In addition, the reference characteristic may be generated by a method other than actual measurement.

Furthermore, for example, in the information processing systems 1 and 1A, the information providing device 2 and the information processing apparatus 10 are separately configured, but these may be integrally configured. That is, the information processing apparatus 10 may be a television receiver, a music player, a recording/reproducing device, a set top box, a game machine, a video camera, a personal computer, a mobile terminal device, or the like.

Furthermore, for example, in the information processing system 1A, the configuration in which the correction parameter calculation unit 18 that calculates the correction parameter using the impulse response is provided in the information processing apparatus 20 on the transmission side has been exemplified, but the correction parameter calculation unit 18 may be provided in the information processing apparatus 10 on the reception side. In this case, the transmission processing unit 32 is only required to transmit an impulse response, and the reception processing unit 31 may receive the impulse response.

Note that the present disclosure can also adopt the following configurations.

(1)

An information processing apparatus including
a control unit
that converts a transfer characteristic of a sound pressure from a speaker device to a listening position into an energy characteristic, and
that calculates a correction parameter for correcting a sound field generated by an output sound of the speaker device using the converted energy characteristic.
   (2)

The information processing apparatus according to (1),
in which acoustic energy in the energy characteristic is calculated by integrating power obtained by squaring a sound pressure of the transfer characteristic for a predetermined time.
   (3)

The information processing apparatus according to (2),
in which the control unit can optionally set the predetermined time in accordance with a user instruction.
   (4)

The information processing apparatus according to any one of (1) to (3),
in which the control unit divides the transfer characteristic into a predetermined number of frequency bands and calculates the correction parameter for each of the divided frequency bands.
   (5)

The information processing apparatus according to (4),
in which the control unit can optionally set a condition of the division in accordance with a user instruction.
   (6)

The information processing apparatus according to any one of (1) to (5),
in which the control unit
acquires an energy characteristic serving as a reference,
calculates a correction coefficient that matches acoustic energy of the converted energy characteristic with acoustic energy of the energy characteristic serving as the reference, and calculates the correction parameter using the calculated correction coefficient.
   (7)

The information processing apparatus according to (6),
in which the transfer characteristic is measured in a user use environment, and
the energy characteristic serving as the reference is obtained by converting a transfer characteristic of a sound pressure from the speaker device measured in an acoustic design environment to an assumed listening position measured in an acoustic design environment.
   (8)

The information processing apparatus according to any one of (1) to (7),
in which the control unit
calculates the correction parameter for each of a plurality of the speaker devices, and
calculates each of the correction parameters by an average value of a calculated value using a transfer function specified by a transfer characteristic for the speaker device to be corrected with the correction parameter to be calculated and a calculated value using a transfer function specified by a transfer characteristic for another speaker device cooperating with the speaker device to be corrected with the correction parameter to be calculated.
   (9)

The information processing apparatus according to any one of (1) to (8), further including
a microphone installed at the listening position,
in which the control unit collects a measurement sound output from the speaker device by the microphone and measures a transfer characteristic of a sound pressure from the speaker device to the listening position.
   (10)

The information processing apparatus according to any one of (1) to (9),
in which the control unit corrects the sound field using the correction parameter and outputs a reproduced sound of an audio signal from the speaker device.
   (11)

An information processing apparatus including
a control unit
that receives a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic, and corrects the sound field using the received correction parameter, and outputs a reproduced sound of an audio signal from the speaker device.
   (12)

An information processing system including:
a speaker device; and
an information processing apparatus including a control unit that converts a transfer characteristic of a sound pressure from the speaker device to a listening position into an energy characteristic, and calculates a correction parameter for correcting a sound field generated by an output sound of the speaker device using the converted energy characteristic.
   (13)

An information processing system including:
a speaker device; and
an information processing apparatus including a control unit that receives a correction parameter transmitted from an information processing apparatus on a transmission side, the information processing apparatus including a control unit that converts a transfer characteristic of a sound pressure from the speaker device to a listening position into an energy characteristic, and calculate the correction parameter for correcting a sound field generated by an output sound of the speaker device using the converted energy characteristic, corrects the sound field using the received correction parameter, and outputs a reproduced sound of an audio signal from the speaker device.
   (14)

An information processing method including:
converting a transfer characteristic of a sound pressure from a speaker device to a listening position into an energy characteristic;
and calculating a correction parameter for correcting a sound field generated by an output sound of the speaker device using the converted energy characteristic.
   (15)

An information processing method including:
receiving a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic; and
correcting the sound field using the received correction parameter, and outputting a reproduced sound of an audio signal from the speaker device.
   (16)

A program for causing a computer to execute:
converting a transfer characteristic of a sound pressure from a speaker device to a listening position into an energy characteristic; and
calculating a correction parameter for correcting a sound field generated by an output sound of the speaker device using the converted energy characteristic.
   (17)

The program according to (16)
the program transmitting the correction parameter to an information processing apparatus including a control unit that corrects the sound field using the correction parameter and outputs a reproduced sound of an audio signal from the speaker device.
   (18)

The program according to (16) or (17),
the program being an application of a portable information terminal, and
collecting a measurement sound output from the speaker device by a built-in microphone of the portable information terminal and measuring the transfer characteristic.
   (19)

The program according to (18)
the program correcting a measurement error of a transfer characteristic of a sound pressure from the speaker device to a listening position due to a difference in frequency characteristic of the built-in microphone by a difference between a transfer function specified by a transfer characteristic of a sound pressure from the speaker device to a nearest position of the speaker device and a transfer function specified by a transfer characteristic of a sound pressure from the speaker device to a listening position.
   (20)

A program for causing a computer to execute:
receiving a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic; and
correcting the sound field using the received correction parameter and outputting a reproduced sound of an audio signal from the speaker device.

### REFERENCE SIGNS LIST

1, 1A Information processing system
2 Information providing device
3 Acoustic output device
4 to 7 Speaker device
10, 20 Information processing apparatus
14 Microphone
16 Control unit
17 Characteristic measurement unit
18 Correction parameter calculation unit
19 Reproduction processing unit
171 Measurement sound reproduction unit
172 Measurement sound recording unit
173 Impulse response calculation unit
181 Frequency band division unit
182 Power characteristic conversion unit
183 Energy characteristic conversion unit
184 Difference characteristic extraction unit
185 EQ parameter calculation unit
191 Correction processing unit
31 Reception processing unit
32 Transmission processing unit

1. An information processing apparatus comprising
a control unit
that converts a transfer characteristic of a sound pressure from a speaker device to a listening position into an energy characteristic, and
that calculates a correction parameter for correcting a sound field generated by an output sound of the speaker device using the converted energy characteristic.

2. The information processing apparatus according to claim 1,
wherein acoustic energy in the energy characteristic is calculated by integrating power obtained by squaring a sound pressure of the transfer characteristic for a predetermined time.

3. The information processing apparatus according to claim 2,
wherein the control unit can optionally set the predetermined time in accordance with a user instruction.

4. The information processing apparatus according to claim 1,
wherein the control unit divides the transfer characteristic into a predetermined number of frequency bands and calculates the correction parameter for each of the divided frequency bands.

5. The information processing apparatus according to claim 4,
wherein the control unit can optionally set a condition of the division in accordance with a user instruction.

6. The information processing apparatus according to claim 1,
wherein the control unit
acquires an energy characteristic serving as a reference,
calculates a correction coefficient that matches acoustic energy of the converted energy characteristic with acoustic energy of the energy characteristic serving as the reference, and calculates the correction parameter using the calculated correction coefficient.

7. The information processing apparatus according to claim 6,
wherein the transfer characteristic is measured in a user use environment, and
the energy characteristic serving as the reference is obtained by converting a transfer characteristic of a sound pressure from the speaker device measured in an acoustic design environment to a position where a listening position is assumed.

8. The information processing apparatus according to claim 1,
wherein the control unit
calculates the correction parameter for each of a plurality of the speaker devices, and
calculates each of the correction parameters by an average value of a calculated value using a transfer function specified by a transfer characteristic for the speaker device to be corrected with the correction parameter to be calculated and a calculated value using a transfer function specified by a transfer characteristic for another speaker device cooperating with the speaker device to be corrected with the correction parameter to be calculated.

9. The information processing apparatus according to claim 1, further comprising
a microphone installed at the listening position,
wherein the control unit collects a measurement sound output from the speaker device by the microphone and measures a transfer characteristic of a sound pressure from the speaker device to the listening position.

10. The information processing apparatus according to claim 1,
wherein the control unit corrects the sound field using the correction parameter and outputs a reproduced sound of an audio signal from the speaker device.

11. An information processing apparatus comprising
a control unit
that receives a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic, and
corrects the sound field using the received correction parameter, and outputs a reproduced sound of an audio signal from the speaker device.

12. An information processing system comprising:
a speaker device; and
an information processing apparatus including a control unit that converts a transfer characteristic of a sound pressure from the speaker device to a listening position into an energy characteristic, and calculates a correction parameter for correcting a sound field generated by an output sound of the speaker device using the converted energy characteristic.

13. An information processing system comprising:
a speaker device; and
an information processing apparatus including a control unit that receives a correction parameter transmitted from an information processing apparatus on a transmission side, the information processing apparatus including a control unit that converts a transfer characteristic of a sound pressure from the speaker device to a listening position into an energy characteristic, and calculate the correction parameter for correcting a sound field generated by an output sound of the speaker device using the converted energy characteristic, corrects the sound field using the received correction parameter, and outputs a reproduced sound of an audio signal from the speaker device.

14. An information processing method comprising:
converting a transfer characteristic of a sound pressure from a speaker device to a listening position into an energy characteristic; and
calculating a correction parameter for correcting a sound field generated by an output sound of the speaker device using the converted energy characteristic.

15. An information processing method comprising:
receiving a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic; and
correcting the sound field using the received correction parameter, and outputting a reproduced sound of an audio signal from the speaker device.

16. A program for causing a computer to execute:
converting a transfer characteristic of a sound pressure from a speaker device to a listening position into an energy characteristic; and
calculating a correction parameter for correcting a sound field generated by an output sound of the speaker device using the converted energy characteristic.

17. The program according to claim 16,
the program transmitting the correction parameter to an information processing apparatus including a control unit that corrects the sound field using the correction parameter and outputs a reproduced sound of an audio signal from the speaker device.

18. The program according to claim 16,
the program being an application of a portable information terminal, and
collecting a measurement sound output from the speaker device by a built-in microphone of the portable information terminal and measuring the transfer characteristic.

19. The program according to claim 18, which corrects a measurement error of a transfer characteristic of a sound pressure from the speaker device to a listening position due to a difference in frequency characteristic of the built-in microphone by a difference between a transfer function specified by a transfer characteristic of a sound pressure from the speaker device to a nearest position of the speaker device and a transfer function specified by a transfer characteristic of a sound pressure from the speaker device to a listening position.

20. A program for causing a computer to execute:
receiving a correction parameter transmitted from an information processing apparatus on a transmission side, the information processing apparatus including a control unit that converts a transfer characteristic of a sound pressure from a speaker device to a listening position into an energy characteristic, and calculate the correction parameter for correcting a sound field generated by an output sound of the speaker device using the converted energy characteristic; and
correcting the sound field using the received correction parameter and outputting a reproduced sound of an audio signal from the speaker device.
